(19) United States
(12) Patent Application Publication
(10) Pub. No.: US 2016/0236358 A1
(43) Pub. Date: Aug. 18, 2016

(54) Nano-/Micro-Actuator and Gripper with Patterned Magnetic Thin Film and Method Thereof

(71) Applicant: National Tsing Hua University, Hsin Chu City (TW)

(72) Inventors: Zung-Hang WEI, Hsin Chu City (TW); Chen-Yu HUANG, Hsin Chu City (TW)

(21) Appl. No.: 14/753,008

(22) Filed: Jun. 29, 2015

(30) Foreign Application Priority Data
Feb. 16, 2015 (TW) 104105438

(51) Int. Cl. B25J 19/00; B25J 7/00

(52) U.S. Cl. CPC B25J 19/007; B25J 7/00

(57) ABSTRACT

The present invention discloses the fabrication of nano-/micro-actuator and gripper with patterned magnetic thin film. The design of the actuator comprised highly flexible stretchable structures and patterned magnetic films. The magnetic thin film with elongated shape caused magnetic anisotropy, resulting in single domain resembled magnetic configuration. The design of the magnetic gripper contains double fixtures, double stretchable structures and patterned magnetic thin films and driven similar process as the actuator. The lateral displacement of the double fixtures causes the fixture move near and away from each other and causes opening and closing behavior.

### STATEMENT OF NO NEW MATTER

The substitute specification as well as this revised specification contains no new matter.

### CROSS-REFERENCE TO RELATED APPLICATIONS

This application claim priority to TAIWAN application Numbered 104105438, filed Feb. 16, 2015, which is herein incorporated by reference in its' integrity.

### TECHNICAL FIELD

The present invention relates to nano-/micro-actuator and gripper, and more specifically to a patterned magnetic thin film with magnetic anisotropy and a highly flexible stretchable structure for micro actuators, and the integration of micro actuators with micro gripping structure for magnetic grippers.

### BACKGROUND OF RELATED ART

Micro/nano structure can be manufactured and designed by using microfabrication technology. There have been numerous designs proposed for bio-grippers, whose actuating mechanism includes thermal, static electric, piezoelectric, direct mechanical contact approaches, and so on. The most commonly used methods are thermal and static electric actuation methods. However, thermal and static electric actuation methods might damage the bio-specimen with its thermal and electrical power; using piezoelectric material the converting efficiency needs to be taken into consideration; and using the direct mechanical contact method it is hard to accurately control over micro-scale movement. Besides, all the actuating mechanisms mentioned above require wires to actuate the devices which are inconvenient to use and also increase the complexity and cost of manufacture.

Magnetic actuators can be actuated by the micro-/nano-scale torque induced by an external magnetic field. Regarding to the magnetic actuator using cantilever beams, the fabrication method of mixing magnetic particles with polymer as the structural material for cantilevers was proposed. It is quite difficult, however, to precisely control the amount of magnetic particles in the polymer material, hence making it hard to control the actuator accurately.

Therefore, in order to overcome the above-mentioned drawback, the present invention provides a process for preparing nano-/micro-actuators and further applied them as micro-grippers.

### SUMMARY

One objective of the present invention is to provide a micro actuator with patterned magnetic thin film which may be applied for nano-/micro-grippers.

According to an aspect of the invention, a method for forming a micro actuator comprises providing a substrate, and forming a stretchable micro structure and an opening on the substrate. Next, a magnetic thin film pattern is formed on the stretchable micro structure, wherein the magnetic thin film pattern has high magnetic anisotropy to maintain single domain resembled magnetic configuration. Finally, a portion of the substrate under the stretchable micro structure is removed to form a suspended stretchable micro structure.

According to another aspect of the invention, a method for forming a micro gripper comprises providing a substrate, and forming a double grippers thin film pattern and an opening on the substrate, wherein the double gripper thin film pattern includes a pair of micro gripper arms, each has a high flexible micro gripper structure which locate on one end of the stretchable micro structure with magnetic thin films pattern. Next, a magnetic thin film pattern is formed on the stretchable micro structure, wherein the magnetic thin film pattern has high magnetic anisotropy to maintain single domain resembled magnetic configuration. Finally, a portion of the substrate under the double grippers thin film pattern is removed to form a suspended stretchable micro structure and micro gripper structure.

In an aspect, material of the substrate is silicon. The stretchable micro structure comprises polymer or silicon oxide. The magnetic thin film pattern is performed by a step of forming a photoresist layer on a magnetic thin film, and performing a step of a photolithography process and an etching process for the photoresist layer. The magnetic thin film pattern is formed on the stretchable micro structure by performing a step of forming a second photoresist layer on the stretchable micro structure, and performing a step of a photolithography process for the second photoresist layer and depositing a magnetic material on the opening after photolithography process. The second photoresist layer is removed to form an opening on edge of the stretchable micro structure and micro gripper structure, for facilitating removing a portion of the substrate under the stretchable micro structure and micro gripper structure.

### BRIEF DESCRIPTION OF THE DRAWINGS

The components, characteristics and advantages of the present invention may be understood by the detailed descriptions of the preferred embodiments outlined in the specification and the drawings attached:

FIG. 1A-FIG. 1H show schematics of fabrication process of nano-/micro-actuator and gripper with patterned magnetic thin film according to one embodiment of the invention.

FIG. 2 shows the magnetic force exerted on the magnetic thin films of the invention.

FIG. 3 shows magnetic force exerted on patterned magnetic thin film of the actuator as the magnetic field H applied along the positive direction and the opposite direction.

FIG. 4A and FIG. 4B show stretchable micro structure with periodic zigzag or wavy shape according to the invention.

FIG. 5A and FIG. 5B show the stretching of the four-arm actuator with patterned magnetic thin film exerted by magnetic field according to the present invention.

FIG. 6 shows sequential micrographs of two-arm zigzag actuator and four-arm zigzag actuator stretch or compress as the magnetic field H applied along the positive direction (a)-(c) and the opposite direction (d)-(f) with respect to the magnetic field according to the invention.

FIGS. 7A and 7B show the stretch/compress displacement of two-arm zigzag actuator with respect to magnitude of the magnetic field according to the invention.

FIGS. 8A, 8B and 8C show opening and closing behavior of micro grippers with respect to different direction of the magnetic field according to the invention.

FIG. 9 shows opening and closing behavior of micro grippers under different magnitude and direction of the magnetic field according to the invention.

FIG. 10A, FIG. 10B and FIG. 10C show the behavior of gripping and releasing target by micro grippers under the external magnetic field according to the invention.

### DETAILED DESCRIPTION

The invention will now be described in greater detail with preferred embodiments of the invention and illustrations attached. Nevertheless, it should be recognized that the preferred embodiments of the invention is only for illustration. Besides the preferred embodiment mentioned here, the present invention can be practiced in a wide range of other embodiments besides those explicitly described, and the scope of the present invention is expressly not limited except as specified in the accompanying Claims.

Micro actuator with patterned magnetic thin film of the present invention can be wirelessly actuated to manipulate magnetic microstructures by way of magnetic force. Thus, the microstructures may be actuated or driven under special circumstances, such as an aqueous solution or vacuum. The main principle is that magnetic material in an applied magnetic field produces a magnetic moment to make the microstructures to be actuated.

However, under micro/nano scale, the magnetic domain configurations in the magnetic material might affect the behavior of the actuator under an external magnetic field. Therefore, micro-magnetic properties and behavior of magnetic microstructures need to be taken into consideration for the design or selection thereof.

The present invention discloses the fabrication of nano-/micro-actuator and gripper with patterned magnetic thin film. The design of the actuator comprised highly flexible stretchable structures and patterned magnetic films. The magnetic thin film with elongated shape caused magnetic anisotropy, resulting in single domain resembled magnetic configuration. The magnetic moment exerted on magnetic thin film may be controlled by adjusting the magnitude and direction of an external magnetic field, and then driving highly micro flexible stretchable magnetic structures for actuating. The design of the magnetic gripper contains double fixtures, double stretchable structures and patterned magnetic thin films and driven similar process as the actuator. The lateral displacement of the double fixtures causes the fixture moving near and away from each other and causes opening and closing behavior. By controlling the opening and closing behavior of magnetic gripper, the function of grabbing object can be achieved, and due to the native magnetic attraction force of the magnetic thin film, the moving magnetically labeled target in fluid can be actively catch by micro gripper.

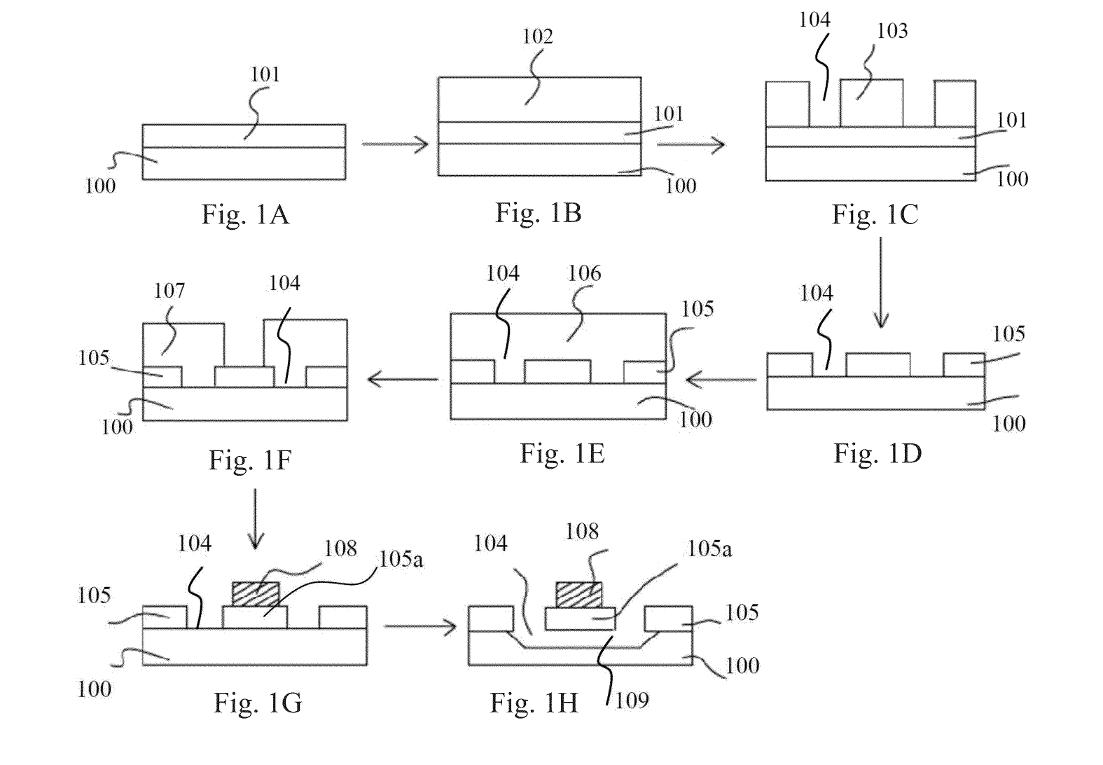

The main feature of the present invention is that magnetic thin film and nano-/micro-actuator and gripper with patterned magnetic thin film may be fabricated by forming magnetic thin film and fabrication process of microstructures, as shown in FIG. 1. In the present invention, the actuator and gripper may be fabricated by using a series of lithography process and thin film deposition, followed by a lift-off process. The process flow of fabrication the micro actuator is shown in FIGS. 1A-1H. Firstly, a substrate 100 such as silicon substrate is provided. Next, the silicon substrate 100 is coated with a thin film layer 101, such as a polymer (Polydimethylsiloxane: PDMS), silicon oxide (such as SiO₂) or silicon nitride layer with 200˜500 nm thick, shown in FIG. 1A. The thin film layer 101 may be formed by an evaporation process or a chemical vapor deposition process. To define the opening area on the thin film layer 101 for wet etching the thin film layer 101, the thin film layer 101 is coated with a photoresist layer 102, such as polymethyl methacrylate (PMMA; 950 A5, MicroChem Corp.) by spin coating, shown in FIGS. 1B. Then, the photoresist layer 102 is performed by a photolithography process to define a patterned photoresist layer 103 and an opening area 104 on the thin film layer 101, shown in FIG. 1C. In this process, the photoresist layer 102 is performed by a developing process to remove light exposing area of the photoresist (positive photoresist) layer 102, and the patterned photoresist layer 103 is then formed.

In one embodiment, developing solution in the developing process is a 1:3 mixture of methyl isobutyl ketone and 2-propanol, wherein the sample with the photoresist layer 102 is developed by such developing solution to remove non-exposing area of the photoresist (negative photoresist) layer 102, and the patterned photoresist layer 103 is then formed. After forming the patterned photoresist layer 103, it always using a scanning electron microscope (SEM; JSM-6390, Jeol) to measure and determine whether the patterned photoresist layer 103 meets the specification of design. As it does not meet the specification of design, parameters (such as thickness of photoresist layer, exposure dose, exposure time, developing time) of fabrication process need to be modified for the patterned photoresist layer 103 close to or fitting the specification of design rule.

Subsequently, a wet etching process is performed such that the thin film layer 101 under the opening area 104 adjacent to the patterned photoresist layer 103 is removed due to the wet etching process, and the thin film layer 101 under the patterned photoresist layer 103 is protected from the thin film layer 101 to be reserved during the wet etching process. After the etching process, the opening area 104 is formed on the silicon substrate 100 and a patterned thin film layer 105 is formed on the silicon substrate 100, shown in FIG. 1D. Remaining photoresist layer is then removed.

Next, the similar procedures are adopted to define the shape of the magnetic tapered thin films on the patterned thin film layer 105. As shown in FIGS. 1E-1H, they show the fabrication process flow of the magnetic tapered thin films. After forming the patterned thin film layer 105, a photoresist layer 106 is formed on the patterned thin film layer 105 to fill into the opening area 104, shown in FIG. 1E. The photoresist layer 106, such as polymethyl methacrylate (PMMA), is formed by spin coating. Then, the photoresist layer 106 is performed by a photolithography process to define a deposition area of the magnetic thin films within an opening area on the thin film layer 105 and form a patterned photoresist layer 107, shown in FIG. 1F. In one embodiment, materials of the magnetic thin films includes Fe film (deposited using Fe target) 90 nm thick with 7 nm Cr (deposited using Cr target) as an adhesive layer and 7 nm Cr as a capping layer to avoid oxidation and corrosion. The adhesive layer may be formed by selected from the material having better adhesion with the underlying thin film layer, such as Ti, Cr. During deposition of the magnetic thin films, the thickness may be monitored by a quartz crystal and the substrate is kept at room temperature during deposition. In one embodiment, the deposition rate is 0.3—1.0 Å per second, and the base pressure of the deposition chamber is 10⁻⁸˜10⁻⁶ torr. No external magnetic fields are present throughout the entire deposition process. After the lift-off process in acetone, the entire photoresist 107 is removed and the magnetic thin films 108 are obtained on the substrate, shown in FIG. 1G.

Subsequently, the substrate 100 under the magnetic thin films 108, within the opening area 104, is performed by an (wet) etching process. In one embodiment, the substrate 100 is immersed in tetramethylammonium hydroxide (TMAH) for two hours to remove the silicon under the cantilever beams for forming a concave structure 109 within the silicon substrate 100, and the suspended silicon based (zigzag) stretchable structures 105a are then obtained to form actuator and gripper with patterned magnetic thin film, shown in FIG. 1H. The magnetic thin films 108 locate on the stretchable structures 105a. The silicon substrate 100 under the cantilever beams can be completed removed to form hollow concave structure 109. Therefore, the substrate 100 may be as a sacrificial layer substrate.

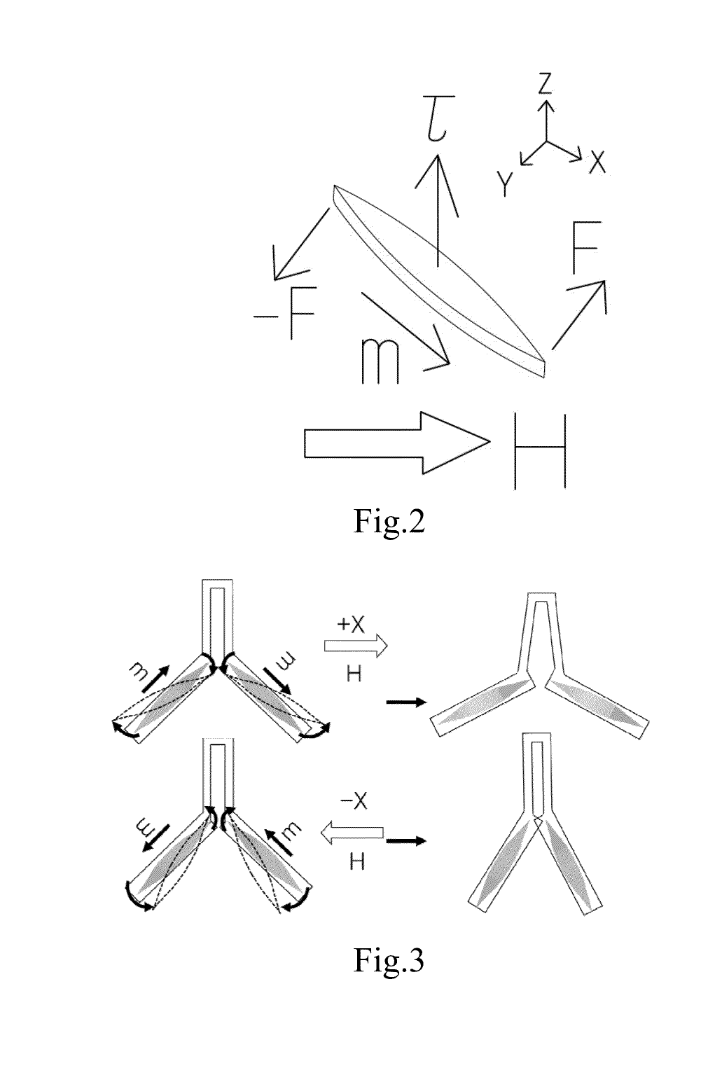

The magnetic actuators and grippers manufactured by the present invention may be driven by adjusting the magnitude and direction of an external magnetic field wirelessly. A uniform magnetic field (H) is applied to the actuators by an electromagnet. Under the uniform magnetic field (H), a pair of opposite forces (F, −F) is exerted on the magnetic thin films 108 on the stretchable structures 105a, and therefore a torque (τ) is created. The torque (τ) induced by the thin film under the uniform magnetic field (H) can be expressed as τ=m×H, where m is the magnetic moment of the magnetic thin film, shown in FIG. 2. The uniform magnetic field H exerted no net force but a torque on the magnetic moment. The torque can be equivalently considered to be the moment of a couple (F, −F). So the magnetic torque (τ) created by magnetic field exerting on the magnetic thin films 108 on the stretchable structures 105a dragged the rigid plate and caused a planar deflection of the rigid plate and the flexible hinge.

By adjusting the direction or magnitude of the magnetic field applied to the elongated oval shape magnetic thin film pattern 108 with high magnetic anisotropy, different magnitude of the magnetic torque (τ) may be created; therefore, the high flexible stretchable structure 105a beneath the magnetic thin film pattern 108 can be stretched outward and compressed inward in response to the magnetic torque (τ), as shown in FIG. 3.

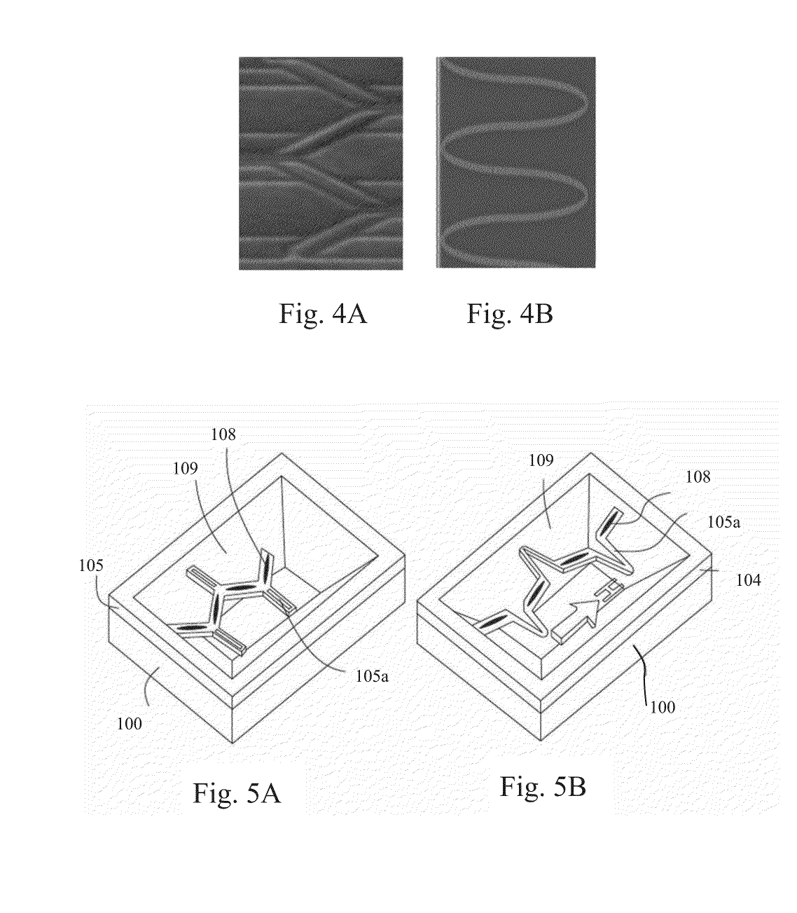

For thin film pattern 105, the actuator includes stretchable micro structure 105a, while the gripping device includes both stretchable micro structure 105a and micro gripper structure 110. The thin film pattern 105 is used to support stretchable micro structure of the patterned magnetic thin film. The shape of the stretchable micro structure 105a may be zigzag or wavy, to increase the freedom of movement, shown in FIGS. 4A and 4B. Materials of the thin film pattern 105 include, but are not limited to polymer (e.g., polydimethylsiloxane silicon), silicon compounds (e.g. silicon dioxide, silicon nitride, Silicon carbide), glass, other film material.

For the magnetic thin films pattern 108, the magnetic thin film has high magnetic anisotropy, either high magnetic-crystalline anisotropy or high shape anisotropy, to maintain the single magnetic domain configuration of magnetic thin film pattern 108. If the magnetic film pattern 108 has very high shape anisotropy, the strength of the torque from each magnetic thin film of the actuators may be controlled by depositing multilayer films consisting of magnetic layer (iron, cobalt, nickel, nickel-iron, nickel-cobalt alloys) spaced with non-magnetic layer (chromium, titanium, aluminum) and adjusting the number the number of deposited “layer pairs”.

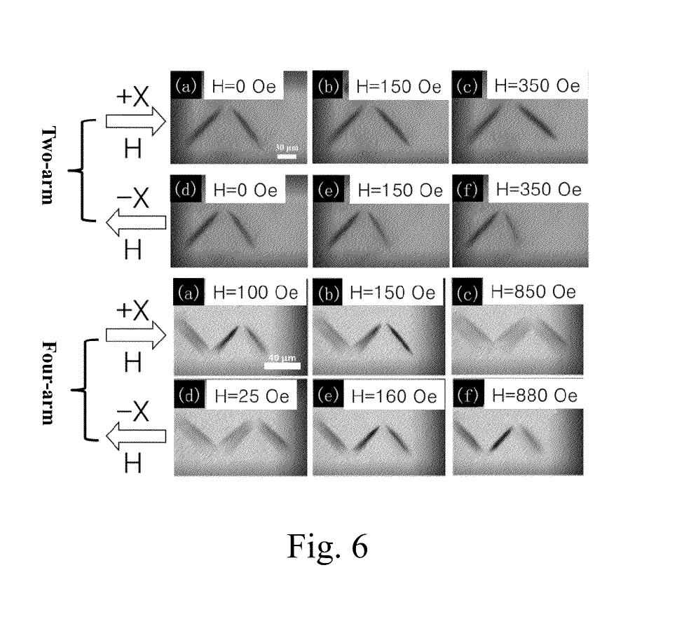

The actuator includes high flexible stretchable micro structure 105a suspends over the substrate, wherein the design of the thin film comprising planar 2D periodic structure with duplicate configuration, such as zigzag or wavy, and not to be limited. Each micro structure 105a contains magnetic thin film pattern 108 with shape anisotropy on its upper surface, wherein three-dimensional structure is shown in FIGS. 5A and 5B. The maximum displacement of actuation may be varied by increase the number of periodic structure of the stretchable micro structure 105a. In a preferred embodiment, when the size of each arms of the zigzag micro structure 105a is the same, the four-arm zigzag actuator has larger displacement than two-arm zigzag actuator, as shown in FIG. 6.

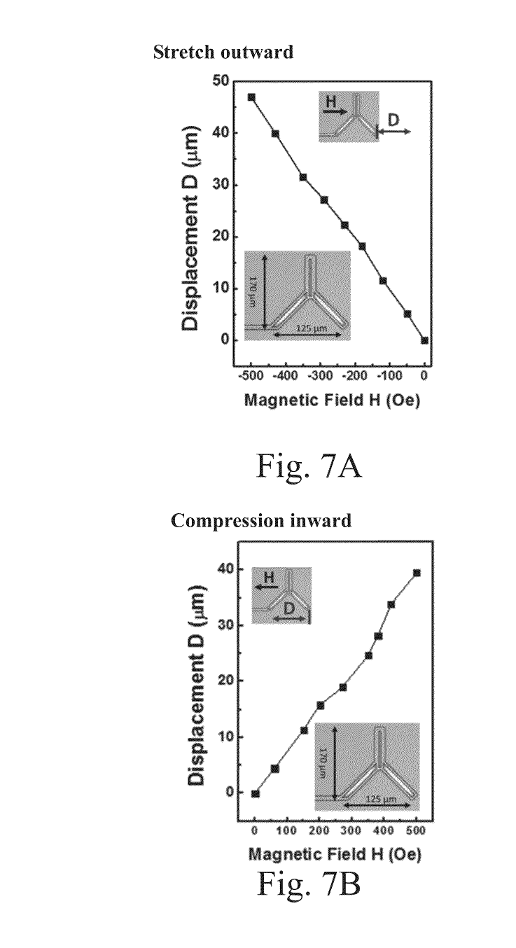

Magnetic moment of the magnetic thin film pattern 108 can be controlled by changing the magnitude and direction of the applied magnetic field, and therefore the stretching/compressing displacement of the stretchable micro structure 105a can be manipulated. The magnetic thin film pattern 108 located on the silica micro magnetic thin film pattern 105a with high shape anisotropy, which can be diamond or ellipse, and the aspect ratio can be 1:2 to 1:10. In one embodiment, the ratio of major to minor axes of the elliptical magnetic thin film pattern is 1:10, which actual lengths of the major and minor axes are 80 μm and 8 μm. As the length and width of the stretchable micro structure 105a is 125 and 170 μm, respectively, the maximum stretching/compressing displacement is up to 40 microns (μm), as shown in FIGS. 7A, and 7B.

According to the actual demand, the size of the stretchable micro structure 105a and the magnetic thin films pattern 108 of the actuator may be scaled up or scaled down to achieve the desired different amount of displacement.

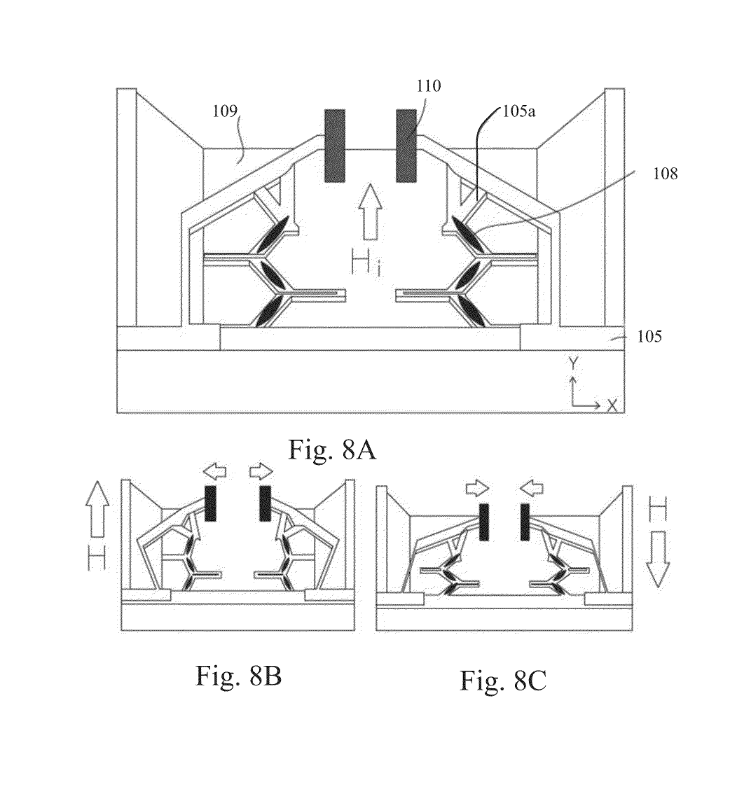

The other feature of the invention lies in combining thin film technology and micromachining to form micro/nano magnetic grippers with patterned magnetic thin films. The magnetic grippers are constructed with a pair of micro gripper arms, each has a high flexible micro gripper structure 110 which locate on one end of the stretchable micro structure 105a with magnetic thin films pattern 108 on the top of its surface. The relative spacing between the two arms of micro gripper depends on the practical application, as shown in FIG. 8A. The anisotropic elongated shape of magnetic thin film pattern 108 is deposited onto the stretchable micro structure 105a. By controlling the external magnetic field, the magnetic films are moved by magnetic torque, and then drag the stretchable micro structure 105a underneath, and therefore lateral displacement of each gripper structures 110 can be created to move them closer or further away to each other, thereby create the opening and closing behavior of the two micro gripper arms. In one embodiment, if the initial magnetic field (Hi) is applied and cause the micro gripper structures 110 to stretch outward, the spacing between the micro gripper structures (pair of micro gripper arms) 110 enlarges, as shown in FIG. 8A. As an external magnetic field (H) is applied in the identical direction as the initial magnetic field (Hi), the spacing (distance) between the micro gripper structures (pair of micro gripper arms) is further enlarging due to the micro gripper structures 110 stretching outward further, as shown in FIG. 8B. As an external magnetic field (H) is applied in the direction opposite to the initial magnetic field (Hi), the spacing between the micro gripper structures (pair of micro gripper arms) 110 reduces due to compression of the micro gripper structures 110, as shown in FIG. 8C. In the inventor's experiment, by changing the magnitude and direction of the magnetic field, actuation (displacement) of the stretchable micro structure 105a is also appeared hysteresis characteristic.

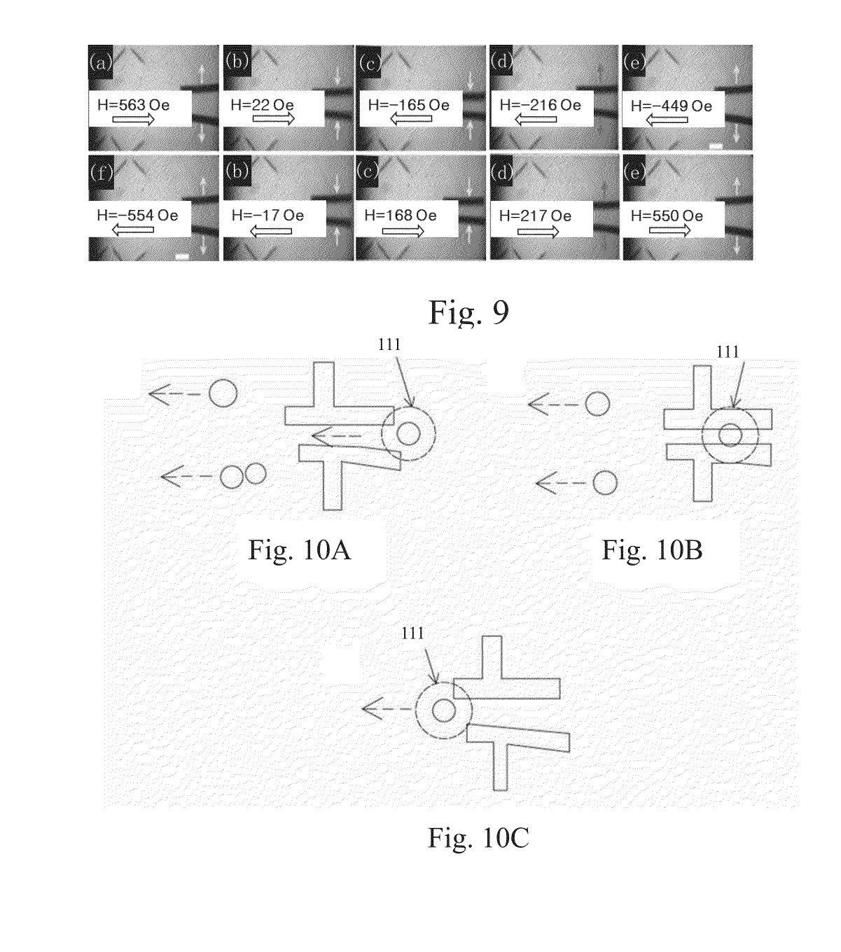

In a preferred embodiment, a chromium (Cr) layer may be formed on the micro gripper structures 110 for conveniently observing actuation of the actuator under a microscope. By providing a varying magnitude and direction of the external magnetic field, magnetic moment of the magnetic film is created to drive the stretchable micro structure 105a to move closer or further away from each other, thereby creating opening and closing behavior of the micro gripper structures 110, as shown in FIG. 9.

The magnetic film on the micro gripper may attract the magnetic target in fluid to move closer to the micro gripper, shown in FIG. 10A. As cells are flowing leftward when a rightward magnetic field is applied, the pair of micro gripper arms move further away from each other, and the target cell 111 flowing over the fluid is not gripped by the micro gripper, as shown in FIG. 10A. As the applied magnetic field changed, the pair of micro gripper arms move closer to each other, which cause the opening behavior of the micro gripper structures 110 and the target cell is then gripped, as shown in FIG. 10B. The target cell can be further released from the micro gripper as shown in FIG. 10C by changing the magnetic field to the opposite direction. For example, if the size of the target cell is 20 micron the amount of displacement of the micro gripper arm may be up to 20 micron. The micro gripper for cells may be essential for biochips, biomedical detection or other biomedical relevant application.

The present invention provides magnetic micro actuator, magnetic micro gripper, wherein the micro actuator may apply for stretching and compressing the target, as a separator for the target and driver of micro device; the micro gripper can be used as gripping device of the target (biological cells) and also be used as robotic arms in minimally invasive surgical.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A method for forming a micro actuator, comprising:
providing a substrate;
forming a stretchable micro structure and an opening on said substrate;
forming a magnetic thin film pattern on said stretchable micro structure, wherein said magnetic thin film pattern has high magnetic anisotropy to maintain single magnetic domain and removing a portion of said substrate under said stretchable micro structure to form a suspended stretchable micro structure.

2. The method in claim 1, wherein material of said substrate comprises silicon.

3. The method in claim 1, wherein material of said stretchable micro structure comprises polymer, silicon oxide or silicon nitride.

4. The method in claim 1, wherein said forming a magnetic thin film pattern comprises a step of forming a photoresist layer on a magnetic thin film, and performing a step of a photolithography process and an etching process for said photoresist layer.

5. The method in claim 1, wherein said removing a portion of said substrate under said stretchable micro structure is performed by an etching process.

6. The method in claim 1, wherein said stretchable micro structure has periodic shape.

7. The method in claim 6, wherein said periodic shape is zigzag or wavy.

8. The method in claim 6, wherein said magnetic thin film pattern has shape anisotropy.

9. A method for forming a micro gripper, comprising:
providing a substrate;
forming a double grippers thin film pattern and an opening on said substrate, wherein said double gripper thin film pattern includes a pair of symmetric micro gripper arms, each has a micro gripper structure which locate on one end of the stretchable micro structure;
forming a magnetic thin film pattern on said stretchable micro structure, wherein said magnetic thin film pattern has high magnetic anisotropy to maintain single magnetic domain; and
removing a portion of said substrate under said double grippers thin film pattern to form a suspended said stretchable micro structure and said micro gripper structure.

10. The method in claim 9, wherein material of said substrate comprises silicon.

11. The method in claim 9, wherein material of said stretchable micro structure comprises polymer, silicon oxide or silicon nitride.

12. The method in claim 9, wherein said forming a double grippers thin film pattern comprises a step of forming a photoresist layer on a magnetic thin film, and performing a step of a photolithography process and an etching process for said photoresist layer.

13. The method in claim 9, wherein said removing a portion of said substrate under said double grippers thin film pattern is performed by an etching process.

14. The method in claim 9, wherein said double grippers thin film pattern has periodic shape.

15. The method in claim 14, wherein said periodic shape is zigzag or wavy.

16. The method in claim 14, wherein said magnetic thin film pattern has shape anisotropy.

17. The method in claim 9, wherein said forming a magnetic thin film pattern on said stretchable micro structure comprises performing a step of forming a photoresist layer on said stretchable micro structure, and performing a step of a photolithography process for said photoresist layer and depositing a magnetic material after said photolithography process.
